(19) United States
(12) Patent Application Publication
(10) Pub. No.: US 2025/0249561 A1
(43) Pub. Date: Aug. 7, 2025

(54) WRENCH ASSEMBLY FOR TIGHTENING FASTENER TO SPECIFIED ROTATIONAL POSITION AT SPECIFIED TORQUE

(71) Applicant: Spirit AeroSystems, Inc., Wichita, KS (US)

(72) Inventor: Bradly Hilker, Wichita, KS (US)

(21) Appl. No.: 19/042,849

(22) Filed: Jan. 31, 2025

Related U.S. Application Data
(60) Provisional application No. 63/549,323, filed on Feb. 2, 2024.

(51) Int. Cl. B25B 23/142; B25B 13/48

(52) U.S. Cl. CPC B25B 23/1422; B25B 13/48

(57) ABSTRACT

A wrench assembly tightens a fastener for a latch mechanism of an openable body panel to a specified torque at a specified rotational position. A keyed socket head couples to a head of the fastener in one and only one rotational orientation. An adapter body connects a torque wrench to the keyed socket head. The torque wrench rotates the wrench assembly to turn the fastener via the keyed socket head. The adapter body defines a wrench reference surface that aligns with a panel reference surface of the openable body panel when the fastener is tightened to the specified rotational position. The torque wrench indicates when the wrench assembly applies the specified torque on the fastener.

### CROSS-REFERENCE TO RELATED APPLICATIONS

This application claims priority to U.S. Provisional Patent Application No. 63/549,323, filed Feb. 2, 2024, which is hereby incorporated by reference in its entirety.

### FIELD

This disclosure generally pertains to a wrench assembly for tightening a fastener to specified rotational position at a specified torque.

### BACKGROUND

High speed vehicles, such as aircraft, often have exterior body panels that are openable (including panels that are fully removable) to allow access to internal components for maintenance and repair. For example, the cowl of an aircraft nacelle typically is formed from body parts that are hingedly connected so that they can be opened to access the engine components inside the nacelle. It is important that openable body panels be securely fastened in the closed positions anytime the vehicle is traveling at high speed. To ensure proper closure of such openable body panels, various latch mechanisms have been developed. Some of these latch mechanisms are complex, with multiple sequential locking features having specific torque requirements. To ensure maintenance personnel comply with the required unlocking sequence, latch mechanisms have been developed that incorporate a compliance linkage that includes one or more mechanical indicators that direct the maintenance person to unlock the locking features in the proper sequence.

### SUMMARY

In one aspect, a wrench assembly for tightening a fastener for a latch mechanism of an openable body panel to a specified torque at a specified rotational position comprises a torque wrench. A keyed socket head is configured to couple to a head of the fastener in one and only one rotational orientation relative to an axis of rotation of the fastener. An adapter body connects the torque wrench to the keyed socket head such that the torque wrench is usable to drive rotation of the wrench assembly about the axis of rotation of the fastener when the keyed socket head is coupled to the head of the fastener. The adapter body comprises a wrench reference surface configured to align with a panel reference surface of the openable body panel when the fastener is tightened to the specified rotational position. The torque wrench is configured to indicate when the wrench assembly applies the specified torque on the fastener.

In another aspect, a wrench assembly for tightening a fastener for a latch mechanism of an openable body panel to a specified torque at a specified rotational position comprises a torque wrench mechanism configured to indicate when the wrench assembly applies the specified torque. An asymmetrical internal socket is configured to mate with a head of the fastener in one and only one rotational orientation relative to an axis of rotation of the fastener. A wrench reference surface has a fixed reference position in relation to the asymmetrical internal socket. The wrench reference surface is configured to align with a panel reference surface of the openable body panel when the wrench assembly tightens the fastener to the specified rotational position.

In another aspect, a wrench assembly for tightening a fastener for a latch mechanism of an openable body panel to a specified torque at a specified rotational position comprises a keyed socket head defining an asymmetrical internal socket configured to mate with a head of the fastener in one and only one rotational orientation relative to an axis of rotation of the fastener. The keyed socket head comprises an external rotational alignment key. An adapter body defines a socket head opening. The keyed socket head is fitted in the socket head opening. The socket head opening has a first axis and includes a keyway for receiving the external rotational alignment key such that the keyed socket head fits into the socket head opening in one and only one rotational orientation with respect to the first axis. The adapter body further defines a torque wrench opening extending along a second axis perpendicular to the first axis. The adapter body comprises an indicator arm defining a wrench reference surface extending along a third axis transverse to the first axis and the second axis. The wrench reference surface is shaped and arranged in relation to the socket head opening and the asymmetrical internal socket is shaped and arranged in relation to the external rotational alignment key so that, when the keyed socket head fitted in the socket head opening mates with the fastener head and the wrench assembly turns the fastener about the axis of rotation, the wrench reference surface aligns with a panel reference surface of the openable body panel when the fastener is in the specified rotational position. A torque wrench has a distal end portion secured in the torque wrench opening and a proximal end portion spaced apart from the distal end portion along the second axis. The torque wrench is configured to apply torque to the fastener via the adapter body and the keyed socket head and configured to indicate when the torque applied to the fastener equals the specified torque.

In another aspect, a method of tightening a fastener of a latch mechanism configured to secure an openable body panel to an aircraft structure comprises coupling a keyed socket head of a wrench assembly to the head of the fastener, turning the wrench assembly by applying torque via a torque wrench mechanism of the wrench assembly until the torque wrench mechanism indicates a specified torque has been reached, and visually determining whether a wrench reference surface of the wrench assembly aligns with a panel reference surface of the openable body panel when the specified torque has been reached. Upon determining that the wrench reference surface is not aligned with the panel reference surface, adjusting shimming of the latch mechanism and then repeating the steps of coupling, turning, and visually determining as before. Upon determining that the wrench reference surface is aligned with the panel reference surface, removing the wrench assembly from the fastener head and installing a mechanical indicator on the fastener head.

Other aspects and features will be apparent hereinafter.

### DESCRIPTION OF THE DRAWINGS

FIG. 1 is an exterior perspective of a body panel of an aircraft nacelle including a portion of a latch mechanism for securely fastening the body panel in the closed position;

FIG. 2 is an interior perspective of a portion of the latch mechanism;

FIG. 3 is an exploded perspective of a fastener of a compliance linkage for the latch mechanism;

FIG. 4 is an elevation of a head of the fastener;

FIG. 5 is a perspective of a wrench assembly for tightening the fastener to a specified torque and a specified rotational position;

FIG. 6 is an exploded perspective of the wrench assembly;

FIG. 7 is an illustration showing the wrench assembly tightening the fastener to the specified torque and specified rotational position; and

FIG. 8 is an illustration showing the wrench assembly beside another wrench assembly configured for tightening another fastener in an opposite direction.

Corresponding parts are given corresponding reference numbers throughout the drawings.

### DETAILED DESCRIPTION

This disclosure generally pertains to a wrench assembly (broadly, a tool) used for tightening a fastener associated with the compliance linkage of a latch mechanism for securely fastening a vehicle body panel (e.g., an aircraft body panel, such as the body panel of an aircraft nacelle, specifically the fan cowl thereof) in a closed position. As will be explained in further detail below, the wrench assembly includes features that are keyed to the geometry of the fastener and the body panel to verify the fastener is tightened to a specified torque at a specified rotational position. The specified rotational position for the fastener corresponds with the proper position for a mechanical indicator that inhibits a maintenance person from unlatching the latch mechanism out of sequence. The specified torque ensures that the latch mechanism is securely fastened. Before describing the wrench assembly, certain components of an illustrative embodiment of a latch mechanism will be described. The illustrative latch mechanism is described for purposes of better understanding the wrench assembly, which is the principal subject of this disclosure. Hence, only the parts of the latch mechanism helpful for understanding the operation of the wrench assembly are described herein.

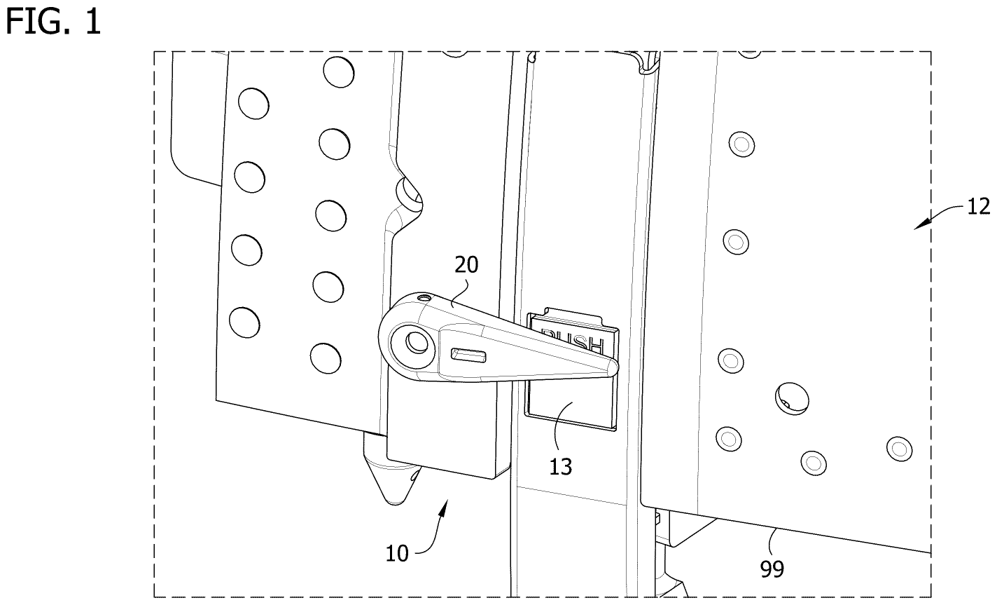

Referring to FIGS. 1-4, a latch mechanism 10 for releasably securing an openable body panel 12 in a closed position is generally indicated at reference number 10. The illustrated openable body panel 12 is part of the cowl of an aircraft nacelle. The principles of the present disclosure may, however, be adapted for wrench assemblies that are used to tighten fasteners for latch mechanisms used with other types of openable body panels. In that regard, it will be understood that the specific geometry of the wrench assembly shown in the later drawings is suited to the particular body panel 12 and latch mechanism 10 depicted in FIGS. 1-4. Wrench assemblies in accordance with the present disclosure will have different geometries to suit different configurations of openable body panels and latch mechanisms.

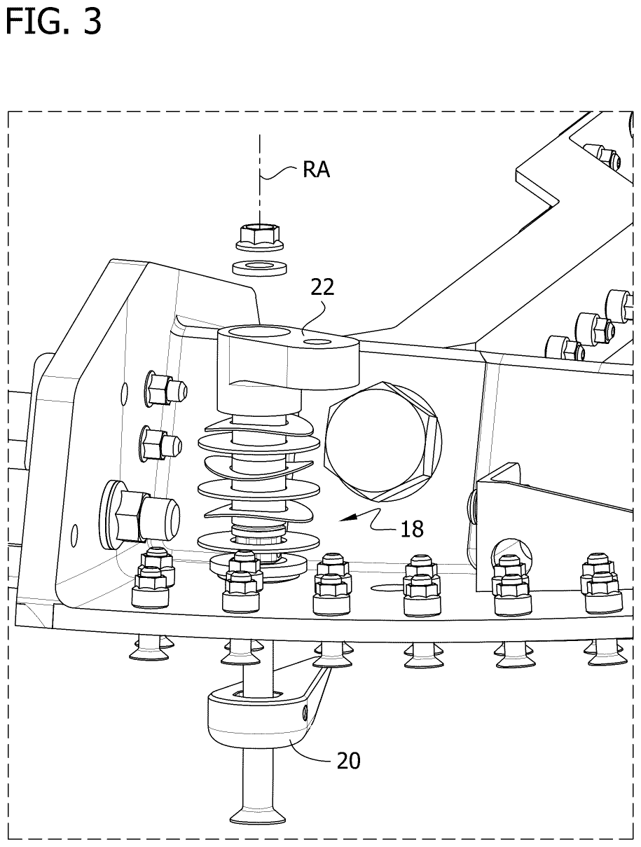

The latch mechanism 10 incorporates a compliance linkage 16 used to ensure that maintenance personnel follow a specified unlatching sequence whenever the latch mechanism 10 is actuated to unlatch the body panel 12. More particularly, the compliance linkage 16 ensures that a second latch release actuator 13 (FIG. 1) of the latch mechanism 10 is not actuated until after a first latch release actuator (not shown) is actuated in accordance with the specified unlatching sequence for the latch mechanism 10. The compliance linkage 16 includes a fastener 18 that has an outer end portion on the exterior of the cowl and an inner end portion located inside the cowl. The outer and inner end portions of the fastener 18 are spaced apart along an axis of rotation RA (FIG. 3). An indicator flag 20 (broadly, a mechanical indicator) is configured to be mounted on the outer end portion of the fastener 18. The inner end portion of the fastener 18 comprises a cam member 22.

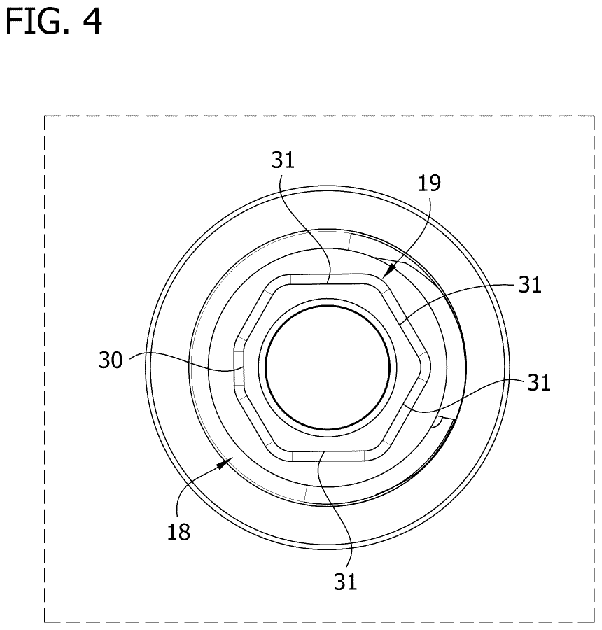

Referring to FIG. 4, the outer end portion of the fastener 18 comprises an asymmetrical fastener head 19 having a rotational keying surface 30. In the illustrated embodiment, the fastener head 19 is generally hexagonal, comprising a plurality of standard-position hexagonal flats 31 and an offset flat 30 that forms the rotational keying surface. The standard position hexagonal flats 31 can have positions specified by any suitable industry standard, e.g., an ISO standard, an ANSI/ASME standard, a DIN standard, a JIS standard, or a BS standard. More broadly, each standard position hexagonal flat 31 is radially spaced from the axis of rotation RA by the same radial distance and has the same radial width. The offset flat 30 comprises a flat that is offset radially inward (relative the axis of rotation RA) in comparison with the standard-position hexagonal flats 31. The offset flat 30 also has a width that is less than the width of the standard position flats 31.

The indicator flag 20 has an internal socket (not shown) with a shape that corresponds to the asymmetrical fastener head 19. That is, the internal socket of the indicator flag 20 comprises a plurality of internal standard-position hexagonal flats (corresponding to the standard-position hexagonal flats 31) and an internal offset flat (broadly, an internal rotational keying surface) that is offset radially inward in comparison with the internal standard-position hexagonal flats. The internal socket of the indicator flag 20 is configured to receive the asymmetrical head 19 of the fastener 18 such that the indicator flag 20 can only mount on the asymmetrical head in one rotational position about the axis of rotation RA. In this way, the indicator flag 20 is keyed or indexed rotationally with respect to the fastener. To properly position the compliance linkage 16, the fastener 18 is tightened to a rotational orientation in which the indicator flag 20 will cover the second latch release actuator 13 when mounted on the asymmetrical head 19.

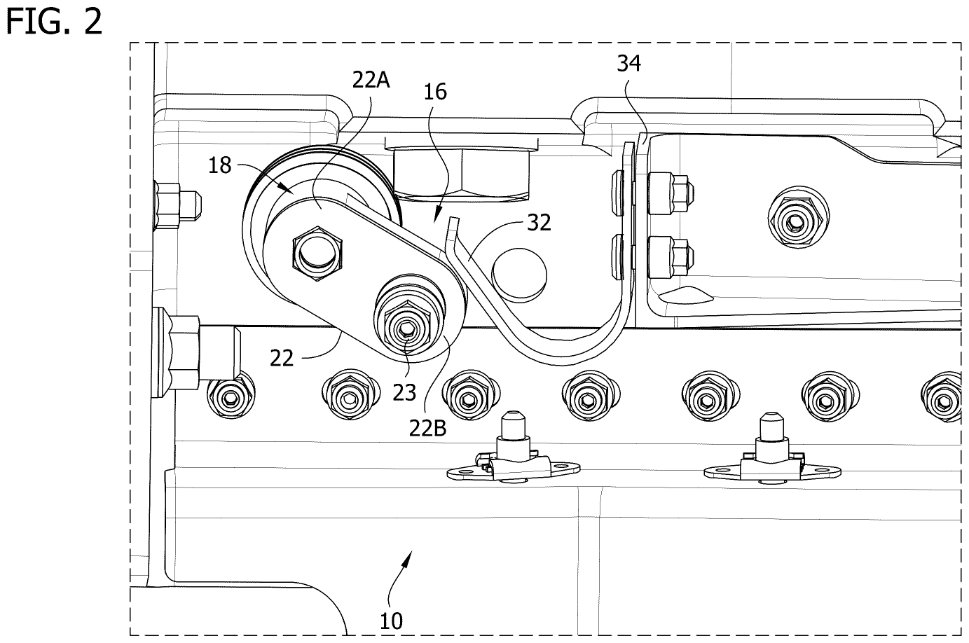

Referring to FIG. 2, the cam member 22 has a first end portion 22A in line with the axis of rotation RA and extends radially outward from the first end portion to a second end portion 22B. A connector 23 is attached to the second end portion 22B of the cam member for coupling the fastener 18 to the remainder of the compliance linkage 16. When the fastener 18 is tightened, the second end portion 22B of the cam member 22 is configured to press against a spring 32. The spring 32 is mounted on a bracket 34. The position of the spring 32 in relation to the fastener 18 and cam member 22 is adjustable by adding or removing shims to adjust the shimming between the spring and the bracket 34. To properly load the compliance linkage 16, the cam member 22 must press against the spring 32 with a specified amount force. In other words, the fastener 18 must be tightened to a specified torque.

Accordingly, it can be seen that each time the latch mechanism 10 is used to securely fasten the body panel 12 in the closed position, the compliance linkage 16 must be properly set by (i) rotating the fastener 18 to the specified rotational position (so that the indicator flag 20 will cover the second release actuator 13), and at the same time (ii) tightening the fastener to the specified torque. Conventional torque wrenches can be used to verify the fastener 18 is tightened to the specified torque, but they do not provide an effective way of determining whether the fastener 18 is at the specified rotational position when the specified torque is reached.

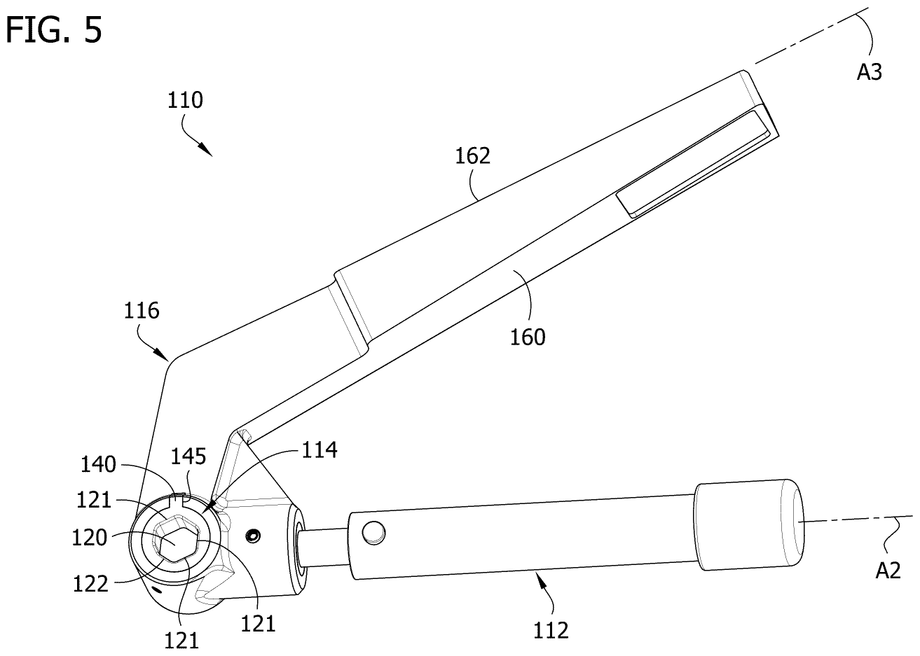

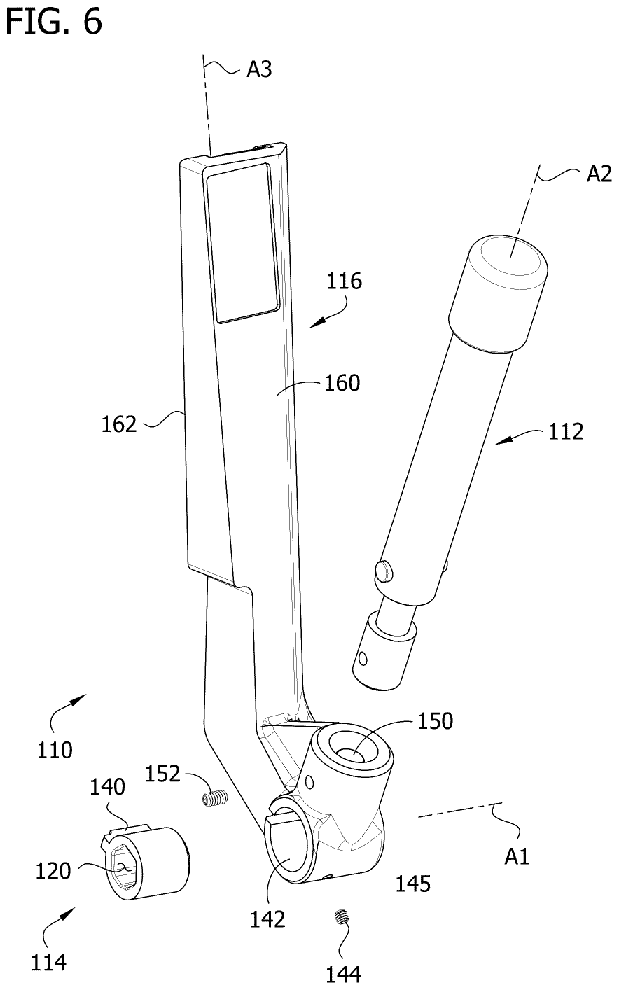

Referring to FIGS. 5-6, a wrench assembly for tightening the fastener 18 to the specified rotational position at the specified torque is generally indicated at reference number 110. The wrench assembly 110 comprises a torque wrench 112 (broadly, a torque wrench mechanism), a keyed socket head 114, and an adapter body 116 configured to connect the keyed socket head 114 to the torque wrench 112. As explained more fully below, the wrench assembly is configured to provide a clear indication of whether the fastener is properly tightened by visually comparing the adapter body 116 to a panel reference surface 99 (FIG. 1) of the body panel 12 when the torque wrench 112 indicates that the proper torque has been applied.

In the illustrated embodiment, the torque wrench 112 is a single-setting torque wrench of the type that makes an audible clicking sound and/or tactile impulse when the specified torque is applied (e.g., a CHA-6 Utica, Single Setting Torque Wrench).

The keyed socket head 114 comprises an asymmetrical internal socket 120 corresponding to the asymmetrical fastener head 19. That is, the internal socket 120 comprises a plurality of internal standard-position hexagonal flats 121 (corresponding to the standard-position hexagonal flats surfaces 31) and an internal offset flat 122 (broadly, an internal rotational keying surface) that is offset radially inward in comparison with the internal standard-position hexagonal flats. The standard-position hexagonal flats 121 in the illustrated embodiment are all spaced apart from a central longitudinal axis of the internal socket 120 by the same radial distance, and each of the standard-position hexagonal flats has the same width. In addition to being offset radially inward in comparison with the standard-position flats 121, the offset flat 122 has a width that is less than the widths of the standard position flats. The internal socket 120 of the keyed socket head 114 is configured to receive the asymmetrical head 19 of the fastener 17 such that the socket head can only operatively couple to the asymmetrical head in one rotational position relative to the axis of rotation RA of the fastener 18 (e.g., with the internal offset flat 122 circumferentially aligned with the keying surface 30 and the internal standard-position hexagonal flats 121 circumferentially aligned with the standard-position hexagonal flats 31). Reception of the asymmetrical fastener head 19 in the asymmetrical internal socket 120 operatively couples the wrench assembly 110 to the fastener such that the fastener 18 and the wrench assembly rotate together about the axis of rotation RA.

The keyed socket head 114 further comprises an external rotational alignment key 140 (broadly, an external keying feature). The external rotational alignment key 140 is used to align the keyed socket head 114 at a predefined rotational orientation in relation to the adapter body 116. In the illustrated embodiment, the keyed socket head 114 has a generally circular outer perimeter and the external rotational alignment key 140 comprises a tab projecting radially outward from the generally circular perimeter. Since (i) the asymmetrical internal socket 120 defines the rotational orientation between the fastener 18 and the keyed socket head 114 and (ii) the external rotational alignment key 140 establishes a predefined position/orientation for the keyed socket head 114 in relation to the adapter body 116, there is a predefined rotational relationship between the adapter body 116 and the fastener 18 whenever the wrench assembly 110 is coupled to the fastener 18 by receiving asymmetrical fastener head 19 in the keyed socket head 114.

The adapter body 116 is suitably a one-piece component (e.g., an integrally formed, such as molded, machined, or additively manufactured, monolithic piece of material) with integral features for operatively coupling to the keyed socket head 114 and the torque wrench 112. For instance, the illustrated adapter body 116 comprises a socket head opening 142 in which to receive the keyed socket head 114. The socket head opening 142 has an axis A1. A set screw 144 extending radially with respect to the axis A1 may be used to secure the keyed socket head 114 in place inside the socket head opening 142. The socket head opening 142 is generally cylindrical but also includes a keyway 145 (broadly, a complementary keying feature to the external keying feature formed by the external rotational alignment key 140) extending along the axis A1 configured for receiving the external rotational alignment key 140. The keyway 145 extends radially outward from a circular inner perimeter surface defining the remainder of the socket head opening. The socket head opening 142 is sized and arranged so that the keyed socket head 114 can be inserted into the socket head opening 142 by movement along the axis A1. But the keyed socket head 114 can only be inserted in one rotational orientation with respect to the axis A1, particularly, the rotational orientation in which the external rotational alignment key 140 is received in the keyway 145. Accordingly, the keyed socket head 114 has a predefined rotational orientation in relation to the adapter body 116.

The illustrated adapter body 116 further comprises a torque wrench opening 150 in which to receive a distal end portion of the torque wrench 112. The torque wrench opening 150 extends along an axis A2. The axis A2 is perpendicular (broadly, transverse) to the axis A1. A set screw 152 extending radially with respect to the axis A2 is used to secure the distal end portion of the torque wrench 112 in place inside the torque wrench opening 150. When the distal end portion of the torque wrench 112 is secured in the torque wrench opening, the length of the torque wrench, which extends from the distal end portion to a proximal end portion, extends generally along the axis A2.

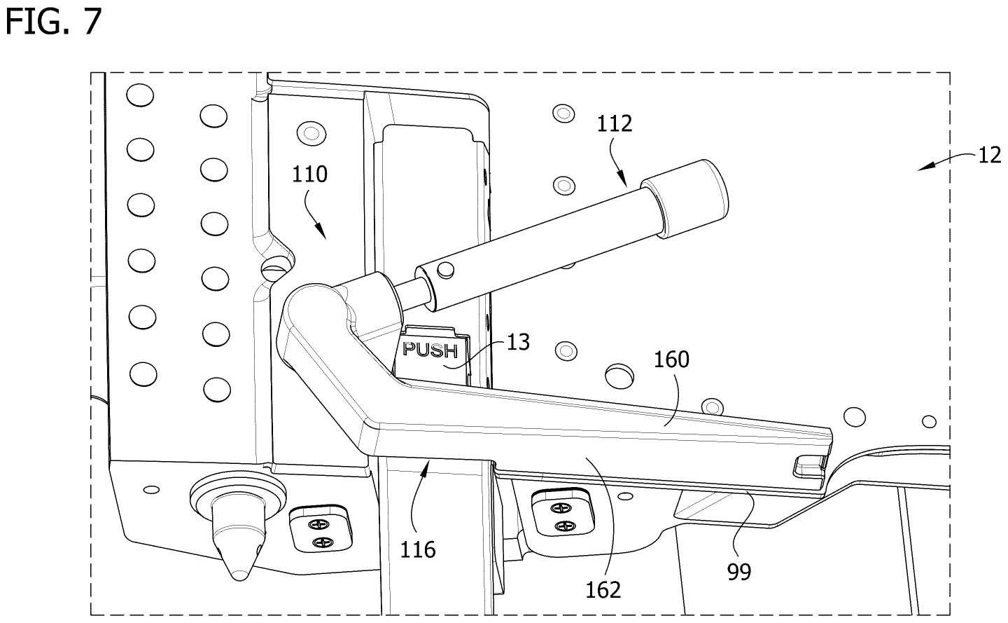

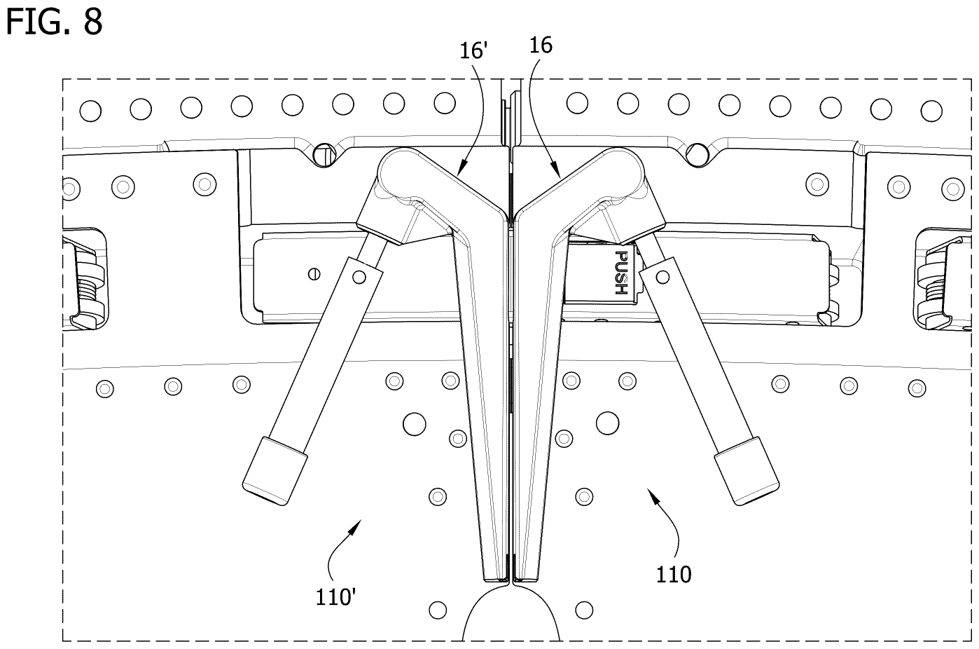

The adapter body 116 further comprises an indicator arm 160 having a wrench reference surface 162 extending along a third axis A3 transverse to the axes A1, A2 of the torque wrench opening 150 and the socket head opening 142. In one or more embodiments, the adapter body 116 is configured so that an included angle α (FIG. 8) between the axis A3 and the axis A2 is in an inclusive range of from 15° to 55°. The wrench reference surface 162 has a predefined angular orientation relative to the axis A2 of the torque wrench opening 150. In addition, the wrench reference surface 162 has a predefined angular orientation (broadly, a fixed reference position) in relation to the asymmetrical internal socket 120 of the keyed socket head 114 when the keyed socket head is fitted in the socket head opening 142. As shown in FIG. 7, this predefined angular orientation is such that when the asymmetrical fastener head 19 is coupled to the keyed socket head 114 by reception in the asymmetrical internal socket 120, the wrench reference surface 162 of the indicator arm 160 will align with the panel reference surface 99 of the body panel 12 when the fastener 18 is in the specified orientation (e.g., the orientation of the fastener 18 in which an indicator flag 20 would cover the second latch release actuator 13 when mounted on the asymmetrical head 19.)

An exemplary method of using the wrench assembly 10 to tighten the fastener 18 will now be briefly described. The wrench assembly 10 is operatively coupled to the fastener 18 by fitting the keyed socket head 114 onto the asymmetrical fastener head 19. As explained above, this positions the adapter body 116 at a predefined rotational orientation in relation to the fastener 18 and its cam member 22. Subsequently, the user grips the torque wrench 112 and turns the fastener 18 to tighten. The torque wrench 112 thereby applies torque to the fastener 18 via the adapter body 116 and the keyed socket head 114. The user tightens until the torque wrench 112 issues a click and/or impulse (or otherwise indicates that the specified torque has been reached). Subsequently, the user compares the position of the wrench reference surface 162 in relation to the panel reference surface 99 of the body panel 12. If the two reference surfaces 99, 162 are aligned as shown in FIG. 7, the user determines that the fastener 18 has been properly tightened to the specified torque in the specified rotational position. The wrench assembly 110 can be removed and the flag indicator 20 can be installed on the fastener head 19.

If the two reference surfaces 99, 162 are misaligned, the user determines that the fastener 18 is not properly installed because it was tightened to the specified torque at a rotational position that is offset from the specified rotational position. In this event, the user would access the latch mechanism 10 to adjust the shimming between the bracket 34 and the spring 32. After the shimming is adjusted, the user can again use the wrench assembly 110 to tighten the fastener 18 to the specified torque and check for proper fastener rotational orientation based on the relative positions of the reference surfaces 99, 162. The steps of adjusting the shimming and re-tightening the fastener can be repeated until the fastener is properly tightened to the specified torque in the specified rotational position.

Referring to FIG. 8, it will be appreciated that wrench assemblies can have various shapes depending on the operation of the fasteners and geometry of the body panels with which they are to be used. For instance, FIG. 8 shows an example wrench assembly 110′ that is similar to the wrench assembly 110 except that it has an adapter body 116′ that is a mirror image of the adapter body 116. The wrench assembly 110 is configured to tighten the fastener 18 in a clockwise direction. The wrench assembly 110′ is configured to tighten its respective fastener (not shown) in a counterclockwise direction.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A wrench assembly for tightening a fastener for a latch mechanism of an openable body panel to a specified torque at a specified rotational position, the wrench assembly comprising:
a torque wrench;
a keyed socket head configured to couple to a head of the fastener in one and only one rotational orientation relative to an axis of rotation of the fastener; and
an adapter body connecting the torque wrench to the keyed socket head such that the torque wrench is usable to drive rotation of the wrench assembly about the axis of rotation of the fastener when the keyed socket head is coupled to the head of the fastener, the adapter body comprising a wrench reference surface configured to align with a panel reference surface of the openable body panel when the fastener is tightened to the specified rotational position,
wherein the torque wrench is configured to indicate when the wrench assembly applies the specified torque on the fastener.

2. The wrench assembly of claim 1, wherein the keyed socket head comprises an external keying feature and the adapter body comprises a complementary keying feature configured to engage the external keying feature of the keyed socket head so that the keyed socket head is mountable on the adapter body in one and only one rotational position.

3. The wrench assembly of claim 2, wherein the external keying feature is an alignment key and the complementary keying feature is a keyway in which the alignment key is received.

4. The wrench assembly of claim 2, wherein the keyed socket head has a generally circular outer perimeter and the external keying feature is a tab projecting radially outward from the generally circular perimeter.

5. The wrench assembly of claim 1, wherein the adapter body defines a socket head opening and the keyed socket head is fitted in the socket head opening.

6. The wrench assembly of claim 5, wherein the socket head opening has a circular inner perimeter and a keyway extending radially outward in relation to the circular inner perimeter and wherein the keyed socket head has a generally circular outer perimeter and a tab projecting radially outward from the generally circular perimeter.

7. The wrench assembly of claim 5, wherein the socket head opening has an axis and wherein the keyed socket head is configured to be inserted into and removed from the socket head opening by movement in relation to the adapter body along the axis.

8. The wrench assembly of claim 6, further comprising a set screw securing the keyed socket head in the socket head opening, the set screw extending radially with respect to the axis.

9. The wrench assembly of claim 1, wherein the adapter body comprises a torque wrench opening extending along an axis transverse to the wrench reference surface, the adapter body configured to mount a portion of the torque wrench in the torque wrench opening.

10. The wrench assembly of claim 9, further comprising a set screw securing the torque wrench in the torque wrench opening, the set screw extending radially with respect to the axis.

11. The wrench assembly of claim 1, wherein the torque wrench is a single-setting torque wrench configured to issue at least one of an audible sound and a tactile impulse when the specified torque is applied.

12. The wrench assembly of claim 1, wherein the adapter body comprises an arm defining the wrench reference surface.

13. The wrench assembly of claim 1, wherein the adapter body comprises a torque wrench opening extending along a first axis and the wrench reference surface extends along a second axis transverse to the first axis, wherein the first axis and the second axis define an included angle therebetween in an inclusive range of from 15° to 55°.

14. The wrench assembly of claim 1, wherein the keyed socket head comprises an asymmetrical internal socket extending along an axis, the asymmetrical internal socket including a plurality of internal standard-position hexagonal flats and an internal offset flat offset radially inward with respect to the axis in comparison with the internal standard-position hexagonal flats.

15. The wrench assembly of claim 1, wherein the adapter body is a single monolithic piece of integrally formed material.

16. A method of using the wrench assembly of claim 1, the method comprising:
coupling the keyed socket head to the head of the fastener;
turning the wrench assembly using the torque wrench to tighten the fastener and stopping turning the wrench assembly when the torque wrench indicates the specified torque has been reached; and
after said stopping turning, visually inspecting the wrench assembly as turned to determine whether the wrench reference surface is aligned with the panel reference surface.

17. The method of claim 16, further comprising determining from said visually inspecting that the wrench reference surface is not aligned with the panel reference, and in response, adjusting shimming of the latch mechanism and repeating the steps of:
coupling the keyed socket head to the head of the fastener;
turning the wrench assembly using the torque wrench to tighten the fastener and stopping turning the wrench assembly when the torque wrench indicates the specified torque has been reached; and
after said stopping turning, visually inspecting the wrench assembly as turned to determine whether the wrench reference surface is aligned with the panel reference surface.

18. The method of claim 16, further comprising determining from said visually inspecting that the wrench reference surface is aligned with the panel reference, and in response, removing the wrench assembly from the fastener head and installing a mechanical indicator on the fastener head.

19. A wrench assembly for tightening a fastener for a latch mechanism of an openable body panel to a specified torque at a specified rotational position, the wrench assembly comprising:
a torque wrench mechanism configured to indicate when the wrench assembly applies the specified torque;
an asymmetrical internal socket configured to mate with a head of the fastener in one and only one rotational orientation relative to an axis of rotation of the fastener; and
a wrench reference surface having a fixed reference position in relation to the asymmetrical internal socket, the wrench reference surface configured to align with a panel reference surface of the openable body panel when the wrench assembly tightens the fastener to the specified rotational position.

20. A wrench assembly for tightening a fastener for a latch mechanism of an openable body panel to a specified torque at a specified rotational position, the wrench assembly comprising:
a keyed socket head defining an asymmetrical internal socket configured to mate with a head of the fastener in one and only one rotational orientation relative to an axis of rotation of the fastener, the keyed socket head comprising an external rotational alignment key;
an adapter body defining a socket head opening, the keyed socket head being fitted in the socket head opening, the socket head opening having a first axis and including a keyway for receiving the external rotational alignment key such that the keyed socket head fits into the socket head opening in one and only one rotational orientation with respect to the first axis, the adapter body further defining a torque wrench opening extending along a second axis perpendicular to the first axis, the adapter body comprising an indicator arm defining a wrench reference surface extending along a third axis transverse to the first axis and the second axis, the wrench reference surface being shaped and arranged in relation to the socket head opening and the asymmetrical internal socket being shaped and arranged in relation to the external rotational alignment key so that, when the keyed socket head fitted in the socket head opening mates with the fastener head and the wrench assembly turns the fastener about the axis of rotation, the wrench reference surface aligns with a panel reference surface of the openable body panel when the fastener is in the specified rotational position; and
a torque wrench having a distal end portion secured in the torque wrench opening and a proximal end portion spaced apart from the distal end portion along the second axis, the torque wrench configured to apply torque to the fastener via the adapter body and the keyed socket head and configured to indicate when the torque applied to the fastener equals the specified torque.
